(19) United States
(12) Patent Application Publication
(10) Pub. No.: US 2013/0033647 A1
(43) Pub. Date: Feb. 7, 2013

(54) Method for Switching Channels in Electronic Device

(71) Applicant: Da-Wei Yuan, Fuqing City (CN)

(72) Inventor: Da-Wei Yuan, Fuqing City (CN)

(21) Appl. No.: 13/195,059

(22) Filed: Aug. 1, 2011

(51) Int. Cl. H04N 5/50

(52) U.S. Cl. 348/731; 348/E05.097

(57) ABSTRACT

A method for switching channels in an electronic device is provided. In the method, a user may press a key to control the electronic device to mark a target channel. When the electronic device has switched channels several times, the user may press another key only once to return to the marked target channel. Furthermore, the user may set an automatic mark time to control the electronic device to automatically mark a target channel if the target channel is displayed for the automatic mark time or the user has watched the target channel for the automatic mark time. When the electronic device has switched channels several times and each switched channel is not displayed for the automatic mark time, the user may press a key only once to return to the marked target channel.

### BACKGROUND OF THE INVENTION

1. Field of the Invention

The present invention relates to a method for switching channels and, more particularly, to a method for switching channels in an electronic device such as a television.

2. Description of the Related Art

Traditionally, there are five commonly used methods for switching channels in a television. The first method is to press number keys (0-9) located on a remote controller to enter a channel number of a target channel into the television to directly switch to the target channel. It has the advantage that it can directly switch to any channel or the target channel. It has the disadvantage that it is difficult for a user to memorize the channel number of the target channel and know beforehand what content is broadcast on the switched target channel.

The second method is to press channel up/down keys (CH+/CH−) located on the remote controller to switch channels one by one until switching to a target channel. It has the advantage that it is simple. It has the disadvantage that it is required to switch channels one by one to switch to the target channel and tends to be inefficient.

The third method is to press a last key (LAST) located on the remote controller to switch between a present channel and a last channel. It has the advantage that it is simple. It has the disadvantage that it only provides the switching between the present channel and the last channel so as to result in poor selectivity.

The fourth method is to use a channel or program list having information about channels and their broadcast programs to select a target channel from the channel list to switch to the target channel. It has the advantage that it is visually intuitive. It has the disadvantage that the channels of the channel list are listed in a fixed order so that it is required to browse the channels of the channel list in the fixed order to select the target channel and tends to be inefficient.

The fifth method is to use a multi-picture browsing mode to assist in switching channels. It has the advantage that it provides small windows for previewing contents of the channels. It has the disadvantage that the small windows for previewing the contents of the channels are arranged in a fixed order so that it is required to browse the channels shown in the small windows in the fixed order to select the target channel and tends to be inefficient.

The above-mentioned methods have respective disadvantages that either it is required to memorize the channel number of the target channel, or it is required to switch channels one by one or browse channels in the fixed order to switch to the target channel, or it only provides the switching between the present channel and the last channel. Accordingly, if the target channel is switched to another channel after switching channels several times, it is unable to return to the target channel by pressing a key only once.

### SUMMARY OF THE INVENTION

The present invention is directed to providing a method for switching channels in an electronic device capable of returning to a target channel by pressing a key only once if the target channel is switched to another channel after switching channels several times.

According to one aspect of the present invention, there is provided a method for switching channels in an electronic device. First, when the electronic device receives a command for marking a first channel, the electronic device stores a channel number of the first channel. Next, when the electronic device receives a command for switching channels several times to accordingly switch to a second channel, the electronic device displays a content of the second channel. Finally, when the electronic device receives a command for returning to the marked channel, the electronic device reads the stored channel number of the first channel to accordingly display a content of the first channel.

In the method of the present invention, when the electronic device displays the content of the first channel, a user may press a mark key of an input module of the electronic device to generate the command for marking the first channel being displayed.

In the method of the present invention, when the electronic device displays a channel list, a user may use an input module of the electronic device to select the first channel from the channel list to generate the command for marking the first channel being displayed.

In the method of the present invention, when the electronic device receives the command for marking the first channel, the electronic device may further store a sound volume of the first channel, and when the electronic device receives the command for returning to the marked channel, the electronic device may further read the stored sound volume of the first channel to accordingly display the content of the first channel.

In the method of the present invention, when the electronic device receives the command for returning to the marked channel and reads the stored channel number of the first channel, the electronic device may further determine whether a channel number of the second channel being displayed is the same as the stored channel number of the first channel. If yes, the electronic device does nothing, and if no, the electronic device reads the stored channel number of the first channel to accordingly display the content of the first channel.

In the method of the present invention, the electronic device may be a television for receiving and displaying contents of television channels, so the first and the second channels are television channels. The electronic device may also be a radio receiver for receiving and displaying contents of radio channels, so the first and the second channels are radio channels.

According to another aspect of the present invention, there is provided a method for switching channels in an electronic device. First, when the electronic device receives a command for setting an automatic mark time, the electronic device stores the automatic mark time. Next, when the electronic device activates an automatic mark function and displays a content of a first channel, the electronic device starts to count time to determine whether a display time of the first channel reaches to the automatic mark time. Next, when the electronic device determines that the display time of the first channel reaches to the automatic mark time, the electronic device automatically marks the first channel and accordingly stores a channel number of the first channel. Next, when the electronic device receives a command for switching channels several times to accordingly switch to a second channel, the electronic device displays a content of the second channel. Finally, when the electronic device receives a command for returning to the marked channel, the electronic device reads the stored channel number of the first channel to accordingly display the content of the first channel.

In the method of the present invention, when the electronic device automatically marks the first channel, the electronic device may further store a sound volume of the first channel, and when the electronic device receives the command for returning to the marked channel, the electronic device may further read the stored sound volume of the first channel to accordingly display the content of the first channel.

In the method of the present invention, when the electronic device receives the command for returning to the marked channel and accordingly reads the stored channel number of the first channel, the electronic device may further determine whether a channel number of the second channel being displayed is the same as the stored channel number of the first channel. If yes, the electronic device does nothing, and if no, the electronic device reads the stored channel number of the first channel to accordingly display the content of the first channel.

In the method of the present invention, the electronic device may be a television for receiving and displaying contents of television channels, so the first and the second channels are television channels. The electronic device may also be a radio receiver for receiving and displaying contents of radio channels, so the first and the second channels are radio channels.

Therefore, in the method of the present invention, a user may press a key (i.e. the mark key) to control the electronic device to mark a target channel (i.e. the first channel). When the electronic device has switched channels several times, the user may press another key (e.g. a return key) only once to return to the marked target channel. Furthermore, the user may set an automatic mark time to control the electronic device to automatically mark a target channel if the target channel is displayed for the automatic mark time (i.e. the display time of the first channel reaches to the automatic mark time) or the user has watched the target channel for the automatic mark time. When the electronic device has switched channels several times and each switched channel is not displayed for the automatic mark time, the user may press a key (e.g. a return key) only once to return to the marked target channel.

### BRIEF DESCRIPTION OF THE DRAWINGS

The foregoing and other features of the disclosure will be apparent and easily understood from a further reading of the specification, claims and by reference to the accompanying drawings in which:

FIG. 1 is a flowchart of a method for switching channels in an electronic device according to a first embodiment of the present invention;

FIG. 2 is a flowchart of a method for switching channels in an electronic device according to a second embodiment of the present invention; and

FIG. 3 is a flowchart of a method for switching channels in an electronic device according to a third embodiment of the present invention.

### DETAILED DESCRIPTION OF THE INVENTION

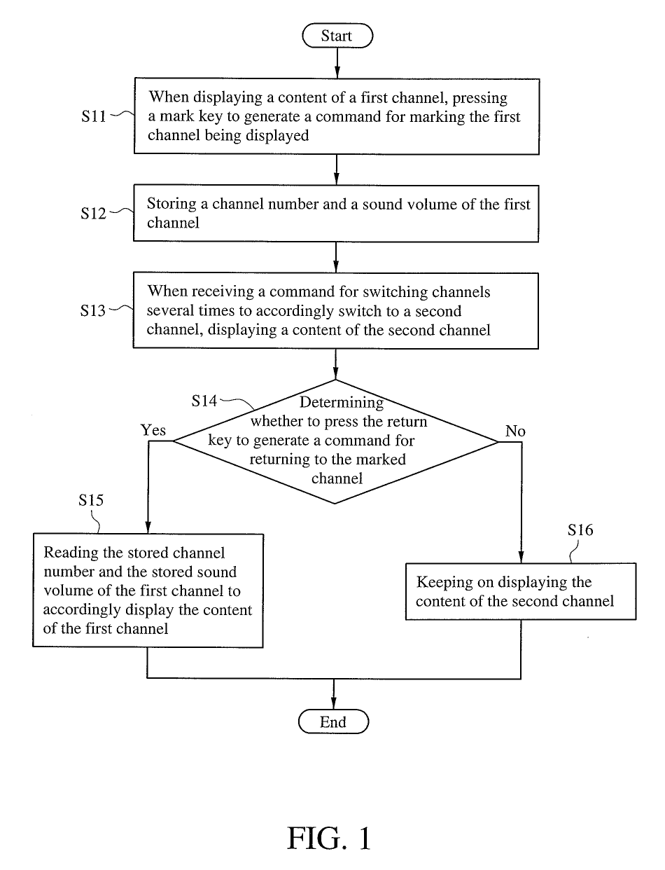

FIG. 1 is a flowchart of a method for switching channels in an electronic device according to a first embodiment of the present invention. Referring to FIG. 1, a method for switching channels in an electronic device includes the following steps. At the step S11, when the electronic device displays a content of a first channel, a user presses a mark key (MARK) of an input module of the electronic device to generate a command for marking the first channel being displayed. In one embodiment, the input module includes keys located on a remote controller for the electronic device or on a body of the electronic device, and the keys may include the mark key (MARK), number keys (0-9), channel up/down keys (CH+/CH−), volume up/down keys (VOL+/VOL−), a last key (LAST) and/or a return key (RETURN). In one embodiment, the electronic device may display a channel list having information about channels and their broadcast programs so that the user may use the input module to select the first channel from the channel list to generate the command for marking the first channel being displayed. At the step S12, when the electronic device receives the command for marking the first channel being displayed, the electronic device stores a channel number of the first channel and a sound volume of the first channel.

At the step S13, when the electronic device receives a command for switching channels several times to accordingly switch to a second channel, the electronic device displays a content of the second channel. For example, when the electronic device displays the first channel, the user presses the keys such as the number keys (0-9) to generate the command for switching channels to control the electronic device to switch from the first channel to a third channel, and then the user presses the keys such as the channel up/down keys (CH+/CH−) to generate the command for switching channels to control the electronic device to switch from the third channel to the second channel. It is understood that, when the electronic device has switched channels several times, the last channel of the second channel being displayed is not necessarily the first channel so that it is unable to return to the first channel by pressing the last key (LAST) once.

At the step S14, the electronic device determines whether the user presses the return key (RETURN) of the input module of the electronic device to generate a command for returning to the marked channel, in which the marked channel is now the first channel. At the step S15, when the electronic device receives the command for returning to the marked channel, the electronic device reads the stored channel number of the first channel and the stored sound volume of the first channel to accordingly display the content of the first channel. At the step S16, when the electronic device does not receive the command for returning to the marked channel, the electronic device keeps on displaying the content of the second channel.

In one embodiment, the electronic device may be a television for receiving and displaying contents of television channels, so the first, the second and the third channels are television channels. In another embodiment, the electronic device may be a radio receiver for receiving and displaying contents of radio channels, so the first, the second and the third channels are radio channels.

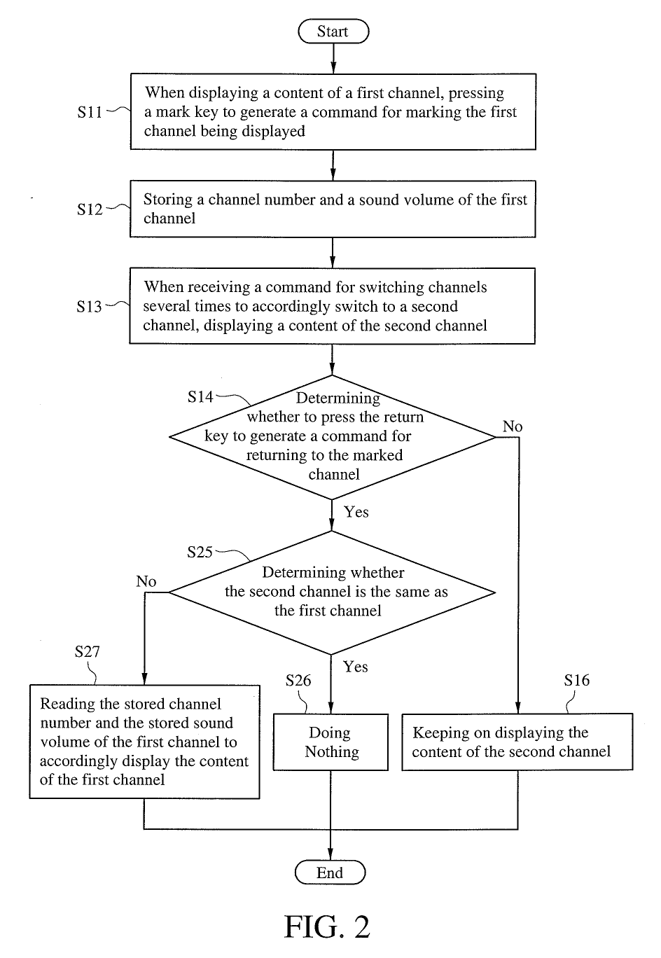

FIG. 2 is a flowchart of a method for switching channels in an electronic device according to a second embodiment of the present invention. Referring to FIG. 2, a method for switching channels shown in FIG. 2 differs from the method for switching channels shown in FIG. 1 in “Yes” path from the decision step S14. When the user presses the return key (RETURN) of the input module of the electronic device to generate the command for returning to the marked channel (“Yes” path from the step S14), the electronic device will receive the command for returning to the marked channel. At the step S25, when the electronic device receives the command for returning to the marked channel, the electronic device determines whether a channel number of the second channel being displayed is the same as the stored channel number of the first channel; that is, determines whether the second channel is the same as the first channel. If the second channel is the same as the first channel, the process goes to the step S26, and the electronic device does nothing. If the second channel is not the same as the first channel, the process goes to the step S27, and the electronic device reads the stored channel number and the stored sound volume of the first channel to accordingly display the content of the first channel.

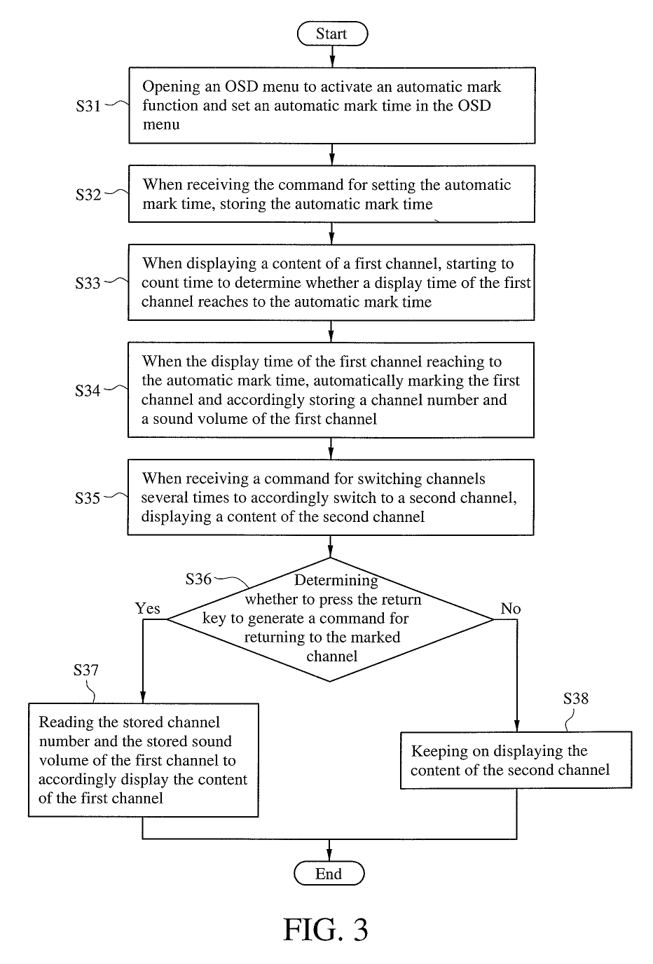

FIG. 3 is a flowchart of a method for switching channels in an electronic device according to a third embodiment of the present invention. Referring to FIG. 3, a method for switching channels in an electronic device includes the following steps. At the step S31, a user uses an input module of the electronic device to open an on-screen display (OSD) menu to activate an automatic mark function and set an automatic mark time in the OSD menu. The user uses the input module to set the automatic mark time to generate a command for setting the automatic mark time. In one embodiment, the input module includes keys located on a remote controller for the electronic device or on a body of the electronic device, and the keys may include a return key (RETURN). At the step S32, when the electronic device receives the command for setting the automatic mark time, the electronic device stores the automatic mark time. The automatic mark time is, for example, 30 seconds, 1 minute, 2 minutes, 3 minutes, 5 minutes, 10 minutes, 20 minutes, 30 minutes, 1 hour or 2 hours.

At the step S33, when the electronic device displays a content of a first channel, the electronic device starts to count time to determine whether a display time of the first channel reaches to the automatic mark time. At the step S34, when the electronic device determines that the display time of the first channel reaches to the automatic mark time, the electronic device automatically marks the first channel and accordingly stores a channel number of the first channel and a sound volume of the first channel. At the step S35, when the electronic device receives a command for switching channels several times to accordingly switch to a second channel, the electronic device displays a content of the second channel, and now the electronic device changes to start to count a display time of the second channel to determine whether the display time of the second channel reaches to the automatic mark time. It is understood that, when the electronic device has switched channels several times, the last channel of the second channel being displayed is not necessarily the first channel so that it is unable to return to the first channel by pressing the last key (LAST) once.

At the step S36, when the display time of the second channel does not reach to the automatic mark time, the electronic device determines whether the user presses the return key (RETURN) of the input module of the electronic device to generate a command for returning to the marked channel. At the step S37, when the electronic device receives the command for returning to the marked channel, the electronic device reads the stored channel number and the stored sound volume of the first channel to accordingly display the content of the first channel, and now the electronic device changes to restart to count the display time of the first channel to determine whether the display time of the first channel reaches to the automatic mark time. At the step S38, when the electronic device does not receive the command for returning to the marked channel, the electronic device keeps on displaying the content of the second channel, and now the electronic device keeps on counting the display time of the second channel to determine whether the display time of the second channel reaches to the automatic mark time.

In one embodiment, the electronic device may be a television for receiving and displaying contents of television channels, so the first and the second channels are television channels. In another embodiment, the electronic device may be a radio receiver for receiving and displaying contents of radio channels, so the first and the second channels are radio channels.

In summary, in the method of the present invention, a user may press a key (i.e. the mark key) to control the electronic device to mark a target channel (i.e. the first channel). When the electronic device has switched channels several times, the user may press another key (i.e. the return key) only once to return to the marked target channel. Furthermore, the user may set an automatic mark time to control the electronic device to automatically mark a target channel if the target channel is displayed for the automatic mark time (i.e. the display time of the first channel reaches to the automatic mark time) or the user has watched the target channel for the automatic mark time. When the electronic device has switched channels several times and each switched channel is not displayed for the automatic mark time, the user may press a key (i.e. the return key) only once to return to the marked target channel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A method for switching channels in an electronic device, comprising:
when the electronic device receives a command for marking a first channel, storing a channel number of the first channel;
when the electronic device receives a command for switching channels several times to accordingly switch to a second channel, displaying a content of the second channel; and
when the electronic device receives a command for returning to the marked channel, reading the stored channel number of the first channel to accordingly display a content of the first channel.

2. The method of claim 1, further comprising:
when the electronic device displays the content of the first channel, pressing a mark key of an input module of the electronic device to generate the command for marking the first channel being displayed.

3. The method of claim 1, further comprising:
when the electronic device displays a channel list, using an input module of the electronic device to select the first channel from the channel list to generate the command for marking the first channel being displayed.

4. The method of claim 1, further comprising:
when the electronic device receives the command for marking the first channel, storing a sound volume of the first channel; and
when the electronic device receives the command for returning to the marked channel, reading the stored sound volume of the first channel to accordingly display the content of the first channel.

5. The method of claim 1, further comprising:
when the electronic device receives the command for returning to the marked channel and reads the stored channel number of the first channel, determining whether a channel number of the second channel being displayed is the same as the stored channel number of the first channel, wherein if yes, doing nothing, and if no, reading the stored channel number of the first channel to accordingly display the content of the first channel.

6. The method of claim 1, wherein the electronic device comprises a television for receiving and displaying contents of television channels comprising the first and the second channels, or the electronic device comprises a radio receiver for receiving and displaying contents of radio channels comprising the first and the second channels.

7. A method for switching channels in an electronic device, comprising:
when the electronic device receives a command for setting an automatic mark time, storing the automatic mark time;
when the electronic device activates an automatic mark function and displays a content of a first channel, starting to count time to determine whether a display time of the first channel reaches to the automatic mark time;
when the electronic device determines that the display time of the first channel reaches to the automatic mark time, automatically marking the first channel and accordingly storing a channel number of the first channel;
when the electronic device receives a command for switching channels several times to accordingly switch to a second channel, displaying a content of the second channel; and
when the electronic device receives a command for returning to the marked channel, reading the stored channel number of the first channel to accordingly display the content of the first channel.

8. The method of claim 7, further comprising:
when the electronic device automatically marks the first channel, storing a sound volume of the first channel, and
when the electronic device receives the command for returning to the marked channel, reading the stored sound volume of the first channel to accordingly display the content of the first channel.

9. The method of claim 7, further comprising:
when the electronic device receives the command for returning to the marked channel and accordingly reads the stored channel number of the first channel, determining whether a channel number of the second channel being displayed is the same as the stored channel number of the first channel, wherein if yes, doing nothing, and if no, reading the stored channel number of the first channel to accordingly display the content of the first channel.

10. The method of claim 7, wherein the electronic device comprises a television for receiving and displaying contents of television channels comprising the first and the second channels, or the electronic device comprises a radio receiver for receiving and displaying contents of radio channels comprising the first and the second channels.
